(19) United States
(12) Patent Application Publication
(10) Pub. No.: US 2002/0068627 A1
(43) Pub. Date: Jun. 6, 2002

(54) Gaming video overlay

(75) Inventor: Robert Linley Muir, Rosebery (AU)

Correspondence Address: SHAHAN ISLAM, ESQ., ROSENMAN & COLIN LLP, 575 Madison Avenue, New York, NY, 10022-2585, US

(73) Assignee: Aristocrat Technologies Australia Pty Ltd., Lane Cove (AU)

(21) Appl. No.: 10/006,731

(22) Filed: Dec. 4, 2001

(30) Foreign Application Priority Data
Dec. 4, 2000 (AU) PR1882

(51) Int. Cl. G06F 17/00

(52) U.S. Cl. 463/30

(57) ABSTRACT

A gaming console is provided which produces audit mode displays via the machine controller instead of the display controller.

This arrangement allows a simple display controller to be used for the basically text based display information of audit mode while continuing to allow high quality graphics to be displayed via the separate display controller during a game playing mode.

A secure controller 11 runs a game program and generates a stream of display commands 19 to a display engine 18 which then generates the video representation of the game via video output signal 17 which is transmitted to a video multiplexer 14 within the secure controller 11. The multiplexer 14 selects between the game video output 17 and an audit mode video signal 26 under control of an output selection function 12 which is under the control of the secure controller. During audit mode the selection function 12 will cause the second input signal 26 to the multiplexer to be displayed, this second signal being generated by the lower performance display controller 13 contained within the secure controller 11.

### Introduction

The present invention relates generally to the security of gaming machines and in particular the invention provides a display controller with improved security.

### BACKGROUND OF THE INVENTION

As gaming mechanisms become more complex and the displayed images require higher resolution, some gaming machines have been made in which the display controller is separate from the machine controller (as shown for example in Casino Data Systems U.S. Pat. No. 6,071,190). This architecture is generally used to allow the use of existing designs for the display controller, such as those used in personal computers, while keeping the advantages of a secure and approvable machine controller without unduly increasing the complexity and hence cost of the game controller.

While the display controller in such a system is reasonably secure, it can never be as secure as the machine controller and could conceivably be tampered with. This would normally be addressed by placing the display controller in a secure cage such that only authorised persons with a high security clearance had access.

### SUMMARY OF THE INVENTION

The present invention consists in a gaming machine comprising a secure game control means, game display engine means responsive to the secure control means to produce a game video output and display means responsive to the game display engine means to display a game image, the secure game control means further comprising second display control means and display signal processing means, the display signal processing means receiving the game video output and an output from the second display control means, and providing an output to the display means comprising the game video output when the machine is in a game playing mode and comprising the output from the second display control means when the machine is in an audit mode, and during the audit mode the output from the second display control means comprises audit data indicating status or setup data of the machine.

In one embodiment the signal processing means is a switching means which switches between the display engine video output during game playing mode and the output of the second display control means during audit mode. However, in a second embodiment the signal processing means is a merging circuit which superimposes the output of the second display control means over the image output from the display engine means. In this second embodiment, not only can secure audit data be presented during audit mode, but secure game information such as payout information and available credit may be displayed during game playing mode.

In the preferred embodiments the game display engine means is a high resolution video graphics controller capable of producing high quality animated 3D graphics images while the second display control means is a lower performance display controller than is the game display engine means.

### BRIEF DESCRIPTION OF THE DRAWINGS

Embodiments of the invention will now be described by way of example, with reference to the accompanying drawings in which:

FIG. 1 is a block diagram of a first embodiment of the invention; and

FIG. 2 is a block diagram of a second embodiment of the invention.

### DETAILED DESCRIPTION OF THE PREFERRED EMBODIMENTS

Embodiments of the current invention provide improvements over existing systems by producing audit mode displays via the machine controller instead of the display controller. In embodiments of the invention two sources of video information are provided, rather than the traditional single source, with the machine controller choosing which one to display as required by the mode of operation. This system allows a simple display controller to be used for the basically text based display information of audit mode while continuing to allow high quality graphics to be displayed via the separate display controller during a game playing mode.

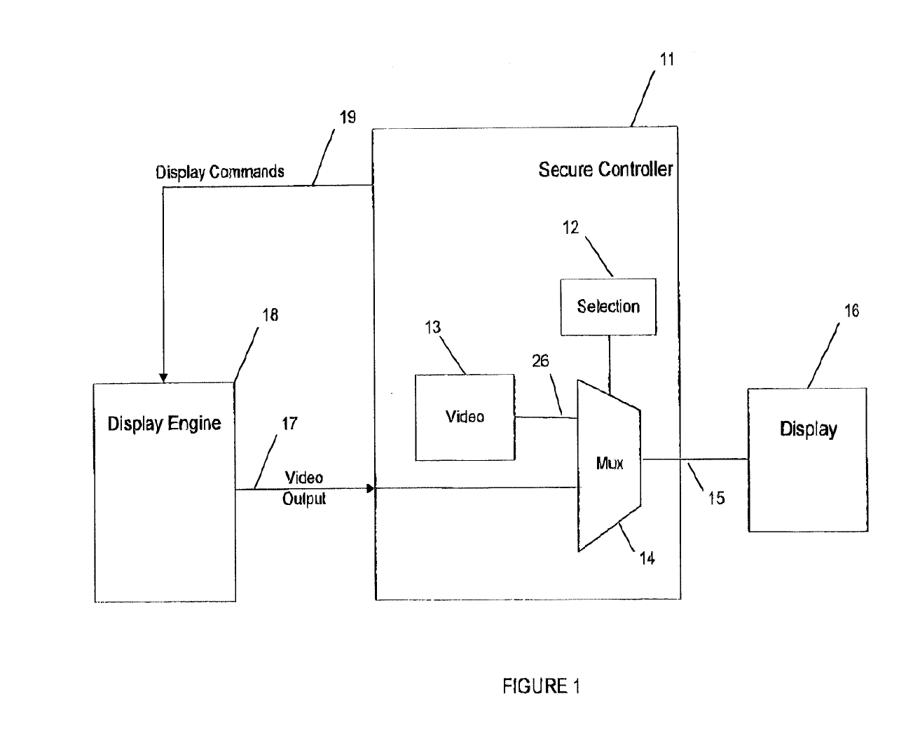

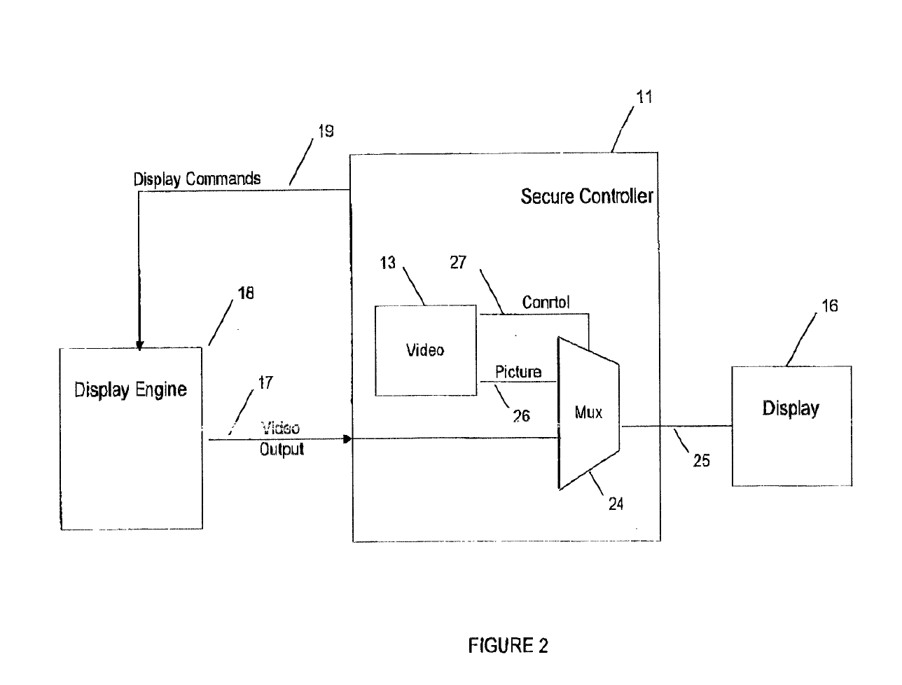

Embodiments of the invention may either employ swapping of the two signals depending upon the mode of the gaming machine as illustrated in FIG. 1 or may merge the two image streams during audit mode as illustrated in FIG. 2.

Referring to FIG. 1, the secure controller 11 runs a game program and generates a stream of display commands 19 to the display engine 18 which then generates the video representation of the game via video output signal 17 which is transmitted to a video multiplexer 14 within the secure controller 11. In prior art machines the video output 17 would have been transmitted directly to the display 15, but in this embodiment the multiplexer 14 selects between the game video output 17 and an audit mode video signal 26 under control of an output selection function 12 which is dependent upon the current mode of the machine and is under the control of the secure controller. During audit mode the selection function 12 will cause the second input signal 26 to the multiplexer to be displayed, this second signal being generated by a low performance display controller 13 contained within the secure controller 11. Therefore, the output 15 of the multiplexer 14 will be derived from the low performance display controller 13 during audit mode and from the high quality display engine 18 during game playing mode.

Referring to FIG. 2 a second embodiment is illustrated in which the multiplexer 14 is replaced by a blending circuit 24 such that the output 25 of the blending circuit 24 is a composite or summation of the inputs to the blending circuit. In the embodiment of FIG. 2 the output signal 17 of the display engine 18 is always passed via the blend circuit 24 to the display 16. But during audit mode the output 26 of the low performance display controller 13 will be added to or superimposed on the video output 17 of the display engine 18. A control signal 27 from the low performance controller will cause the gain of the blend circuit 24 to be modified during audit mode to ensure that the audit text generated by the low performance display controller 13 is visible over the image generated by the video output signal 17.

In the second embodiment a further enhancement is provided whereby important information produced during the game playing mode, such as wins and losses, is produced by the secure controller and displayed via the low performance display controller with the rest of the screen image being produced by the display controller. In this embodiment, even if the display controller has been tampered with, it is not possible to mislead the player about the wins and losses in the game.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A gaming machine comprising a secure game control means, game display engine means responsive to the secure control means to produce a game video output and display means responsive to the game display engine means to display a game image, the secure game control means further comprising second display control means and display signal processing means, the display signal processing means receiving the game video output and an output from the second display control means, and providing an output to the display means comprising the game video output when the machine is in a game playing mode and comprising the output from the second display control means when the machine is in a secure display mode.

2. The gaming machine of claim 1, wherein the signal processing means is a merging circuit which superimposes the output of the second display control means over the image output from the display engine means.

3. The gaming machine of claim 2, wherein an audit mode of the machine is provided which is a secure display mode, such that during the audit mode the output from the second display control means comprises audit data indicating status or setup data of the machine.

4. The gaming machine of claim 3, wherein the signal processing means presents secure audit data during audit mode, and secure game information during game playing mode.

5. The gaming machine of claim 4, wherein the secure game information is payout information and available credit information.

6. The gaming machine of claim 3, wherein the display engine is a high resolution video graphics controller capable of producing high quality animated ₃D graphics images.

7. The gaming machine of claim 6, wherein the second display control means is a lower performance display controller than is the game display engine means.

8. The gaming machine of claim 1, wherein the signal processing means is a switching means which switches between the display engine video output during game playing mode and the output of the second display control means during secure mode.

9. The gaming machine of claim 8, wherein an audit mode of the machine is provided which is a secure display mode, such that during the audit mode the output from the second display control means comprises audit data indicating status or setup data of the machine.

10. The gaming machine of claim 9, wherein the display engine is a high resolution video graphics controller capable of producing high quality animated ₃D graphics images.

11. The gaming machine of claim 10, wherein the second display control means is a lower performance engine display controller than is the game display means.
